(19) United States
(12) Patent Application Publication
(10) Pub. No.: US 2006/0293260 A1
(43) Pub. Date: Dec. 28, 2006

(54) Useful high load concentrate compositions for control of ecto-and endo-parasites

(75) Inventor: Robert B. Albright, Chalfont, PA (US)

Correspondence Address: WYETH;PATENT LAW GROUP, 5 GIRALDA FARMS, MADISON, NJ, 07940, US

(73) Assignee: Wyeth, Madison, NJ (US)

(21) Appl. No.: 11/435,994

(22) Filed: May 17, 2006

Related U.S. Application Data
(60) Provisional application No. 60/683,950, filed on May 24, 2005.

(51) Int. Cl. A01N 43/04

(52) U.S. Cl. 514/28

(57) ABSTRACT

High load concentrate compositions comprising metaflumizone, a substantially water-insoluble anti-parasitic macrolide compound,such as moxidectin, an optional bridging agent, a surfactant, and a suitable carrier solvent are prepared. These compositions may be topically administered to animals, and are useful for preventing or treating ectoparasitic infestations in warm-blooded animals for prolonged periods of time. Additionally, they may be further diluted to provide other types of formulations useable for both topical and oral administration.

This application claims the benefit under 35 U.S.C. §119(e) to U.S. Provisional Application No. 60/683,950, filed May 24, 2005, which is hereby incorporated by reference in its entirety.

### BACKGROUND OF THE INVENTION

Arthropod ectoparasites commonly infecting warm-blooded animals include ticks, mites, lice, fleas, blowfly, the ectoparasite Lucilia sp. of sheep, biting insects including keds (Melophagus ovinus) and migrating dipterous larvae such as Hypoderma sp. and Dermataobia in cattle, Gastrophilus in horses and Cuterebra sp. in rodents.

Helminthiasis is a widespread disease found in many animals and is responsible for significant economic losses throughout the world. Among the helminths most frequently encountered are the group of worms referred to as nematodes. The nematodes are found in the gastrointestinal tract, heart, lungs, blood vessels and other body tissues of animals and are a primary cause of anemia, weight loss and malnutrition in the infected animals. They do serious damage to the walls and tissue of the organs in which they reside and, if left untreated, may result in death to the infected animals.

The nematodes most commonly found to be the infecting agents of ruminants include Haemonchus and Ostertagia generally found in the abomasum; Cooperia, Trichostrongylus and Nematodirus generally found in the intestinal tract, and Dictyocaulus found in the lungs. In non-ruminant animals, important nematodes include Toxocara and Ancylostoma in the intestine and Dirofilaria in the heart of dogs and cats; Ascaridae in the intestine of swine; and large and small strongyles in equines.

Arthropod ectoparasites commonly infecting warm-blooded animals include ticks, mites, lice, fleas, blowfly, the ectoparasite Lucilia sp. of sheep, biting insects and migrating dipterous larvae such as Hypoderma sp. in cattle, Gastrophilus in horses and Cuterebra sp. in rodents.

Anti-parasitic macrolide compounds such as LL-F28249α-λ compounds, 23-oxo or 23-imino derivatives of LL-F28249α-λ compounds, including, but not limited to, moxidectin, milbemycin compounds, including but not limited to milbemycin oxime, avermectin compounds, including, but not limited to abamectin, ivermectin, and mixtures thereof, are useful for the prevention and control of helminthiasis and infection by acarids and arthropod endo- and ectoparasites in warm-blooded animals.

Metaflumizone is useful for the prevention and control of infestation by ectoparasites in warm-blooded animals. Topical administration of this active is a preferred method for administering this compound.

To provide useful protection against both endoparasitic infections and ectoparasitic infection or infestation in warm-blooded animals it is desirable to use formulations having a relatively high loading of active agent, but such formulations must be stable, both with respect to the physical formulation, and also, with respect to the chemical stability of the actives. Metaflumizone is one of several useful insecticidal agents which have found particular application for the control of fleas and ticks on animals, particularly companion animals such as dogs, cats and horses. It is particularly advantageous in that it can provide 4-6 weeks of protection from fleas and ticks in companion animals, but it would be potentially useful for many other species if suitable formulations could be developed. Nonetheless, formulation of metaflumizone is made difficult by its insolubility in many solvents, and its instability in the presence of primary alcohols.

It is the object of the present invention to provide a method for preventing, controlling or treating helminth, acarid or arthropod endo- or ectoparasitic infection or infestation in warm-blooded animals which method comprises topically administering to the warm-blooded animals an anthelmintically, acaricidally or arthropod endo- or ectoparasiticidally effective amount of a nonaqueous composition which comprises about 0.1 to 10% w/v of a substantially water-insoluble anti-parasitic macrolide compound, about 5% to about 40% of metaflumizone; about 0% to about 15% of a bridging or penetrating agent; about 2 to 8% of a surfactant, and about 50 to 80% w/v of a pharmaceutically acceptable water-miscible or water immiscible solvent or solvent system as the carrier.

It is also an object of the present invention to provide a versatile composition for topical administration which comprises a relatively high loading of metaflumizone in combination with an anti-parasitic macrolide compound, and which will provide protection from ecto- and endo-parasitic infestation. Most advantageously, the formulation can function as a concentrate, which with simple modifications, can be extended to use for a wide variety of other animals. Thus, the concentrated formulation can be utilized as a small volume spot-on formulation, for instance, for protection of companion animals, while further dilutions can be utilized as conventional pour-on products for farm animals, with still further dilutions utilizable for sprays and application to the feed.

It is also an object of the present invention to provide a method for preventing or treating acarid or arthropod ectoparasitic infestation in warm-blooded animals, using the compositions of the invention.

It is another object of this invention to reduce or control the proliferation of such insects in warm-blooded animals for prolonged periods of time by a topically applied active, with the formulation being mild and gentle enough to avoid adverse skin reactions upon administration, yet with the ability to be retained in the animal's skin and/or coat over the time needed for protection.

These and other objects of the present invention will become more apparent from the description thereof set forth below and the appended claims.

### SUMMARY OF THE INVENTION

The present invention provides high-load concentrate compositions for topical administration which comprise on a weight to volume basis:
about 0.1 to about 10% of substantially water-insoluble anti-parasitic macrolide compound, especially, moxidectin:
about 5% to about 40% of metaflumizone;
about 0% to about 15% of a bridging or penetrating agent;
about 2 to about 8% of a surfactant and
about 50% to about 80% of a carrier solvent.

The present invention further provides a method for preventing or treating ectoparasitic and endoparasitic infection or infestation in a warm-blooded animal which method comprises topically administering to the animal an acaricidally or arthropod ectoparasiticidally effective amount of the composition of this invention.

### DETAILED DESCRIPTION OF THE INVENTION

In accordance with the present invention, the high load concentrate compositions comprise a substantially water-insoluble anti-parasitic macrolide compound, especially, moxidectin, metaflumizone; an optional bridging agent or penetration enhancer, a surfactant, and a carrier solvent. The invention also provides a method for preventing or treating acarid or arthropod ectoparasitic infection or infestation in warm-blooded animals by topical application of the aforesaid formulations.

Preferred high load concentrate compositions of this invention comprise on a weight to volume basis:
About 0.1 to about 10% of a substantially water-insoluble anti-parasitic macrolide compound, especially, moxidectin
about 5% to about 40% of metaflumizone;
about 0% to about 15% of a bridging or penetrating agent;
about 2 to about 8% of a surfactant and
about 50% to about 80% of a carrier solvent.

While not wishing to be bound by any particular theory, it is believed that the compositions of the present invention have the requisite stability by virtue of physical and or chemical interactions between the surfactant and the metaflumizone. The exact nature of the interactions is unknown, but apparently the surfactant stabilizes the metaflumizone in solution so as to ensure that the resultant formulation retains the desired physical characteristics over time, without loss of potency of the active. Further, the formulation is sufficiently viscous to be retained upon the animal's skin, hair, and be released over the desired period of time.

Uniquely, it has been found these high load concentrate compositions can be further utilized to prepare more dilute compositions for application in various other manners, i.e., for use as a pour-on for large animals, as a spray for large animals or for outdoor use, and as a water-dilutable formulation for addition to the feed and/or water supply of animals under treatment. This has the dual advantage of providing a concentrated formulation that can be shipped to the end-user for dilution and use, or to an intermediate formulator to prepare the compositions. The high loading of metaflumizone in the formulation thus provides a small volume of formulation to use as a “spot-on” formulation, for instance, for companion animals, especially felines. The concentrate can then be diluted by an appropriate organic solvent for use as a pour-on or in a spray, or with water, to provide the feed/water additive.

Metaflumizone is described in U.S. Pat. No. 5,543,573, and U. S. Published Application 2004-0122075A1, both incorporated herein by reference

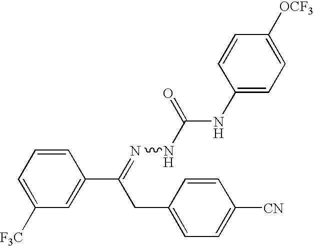

Chemically, metaflumizone is known as (E Z)-2-[2-(4-cyanophenyl)-1-[3-(trifluoromethyl)phenyl]ethylidene]-N-[4-(trifluoromethoxy)phenyl]hydrazinecarboxamide.

The substantially water-insoluble anti-parasitic macrolide compounds useful for the compositions of the present invention are well-know in the art, and are described in detail in, for instance, “Macrocyclic Lactones in Antiparasitic Therapy,” edited by J. Vercruysse and R. S. Rew, CABI Publishing, London, 2002. Such macrolide compounds are subclassed into avermectins and milbemycins, with avermectins being glycosylated milbemycins. Highly preferred, due to its persistency of activity, and its environmental friendliness, is the milbemycin moxidectin, sold in various forms for administration under the Cydectin® tradename.

Bridging agents or penetrating agents or enhancers suitable for use in the compositions of this invention include, but are not limited to, alkyl methyl sulfoxides (such as dimethyl sulfoxide, decylmethyl sulfoxide and tetradecylmethyl sulfoxide); pyrrolidones (such as 2-pyrrolidone, N-methyl-2-pyrrolidone and N-(2-hydroxyethyl) pyrrolidone); laurocapram; and miscellaneous solvents such as acetone, dimethyl acetamide, dimethyl formamide, tetrahydrofurfuryl alcohol, cineole, N,N-diethyl-3-methylbenzamide (DEET), isopropyl myristate (IPM) and dimethyl isosorbide. Other bridging agents include amphiphiles such as L-amino acids, and fatty acids. Additional bridging agents are disclosed in Remington: The Science and Practice of Pharmacy, 19^{th} Edition (1995) on page 1583. Typically, the penetrating agent is used at a level of about 10% w/v of the formulation where the end use is for a topical application, but this may vary, especially when the end use of the composition is for oral administration.

The surfactant utilized in the present invention may be a single surfactant, or a mixture of two or more surfactants, again, in part dependent upon whether the end use of the composition is topical or oral. The surfactant should be non-irritating, and non-toxic. Preferred are non-ionic, low foaming surfactants, such as the alcohol alkoxylate surfactants, with those such as nonylphenol ethoxylate (sold under the tradename Surfonic N-95), and alcohol alkoxylates (sold under the tradename Synperonic® NCA by Uniqema), and the polyethoxylated caster oil surfactants (also known as macrogolglycerol ricinoleate, and sold under the Cremaphore® EL tradename by BASF) being especially suitable. Also useful are ionic surfactants such as sodium lauryl sulfate and dioctyl sodium sulfosuccinate.

Typically, the surfactant is utilized at a level of about 2 to about 8% w/v of the composition, but this may vary somewhat depending upon the end use of the composition. In the case where the end use of the concentrate is as a spray formulation, or as a water-dispersible feed /water additive, it may be desirable to add a further surfactant to ensure that the diluted formulation will be a unitary phase. This ensures that the spray will not block the spray nozzle, and that the active will be dispersed equally throughout the diluted product. In such cases, the additional surfactant may be added to the concentrate formulation, or added to the end use formulation with the diluting solvent. Particularly useful surfactants for use with an organic solvent diluent are non-ionic surfactants such as polyethoxylated castor oil, sold under the tradename Cremophor® EL by BASF Corporation.

The carrier solvent for the compositions of the present invention may be a single solvent, or a mixture of solvents. Due to the instability of metaflumizone in the presence of primary alcohols, preferred solvents are non-hydroxyl-group-containing solvents, especially those such as γ-hexalactone (gamma-hexalactone). Optionally, other such solvents such as N,N-diethyl-m-toluamide, eucalyptol, dimethyl isosorbide, diisopropyl adipate and/or methoxypropyl acetate (1-methoxy-2-propyl acetate) can be utilized in combination with the y-hexalactone to comprise the carrier solvent.

To manufacture the high load concentrate composition of the present invention, the metaflumizone is dissolved in the carrier solvent or solvents, and the surfactant and bridging agent, if desired added to the mixture. This composition can then be utilized as a high load spot-on, or further diluted for additional uses. An especially preferred composition for topical administration to warm-blooded animals comprises, on a weight to volume basis, about 20% to about 30% metaflumizone; 0.5% moxidectin, about 10% of a bridging or penetrating agent, especially dimethyl sulfoxide, about 2 to-about 8%, and especially about 5%, of a non-ionic, low foam surfactant, and about 50-60% carrier solvent, especially γ-hexalactone.

The high load concentrate compositions of this invention may further comprise other agents known in the art, such as preservatives (e.g., methylparaben and propylparaben), colorants, antioxidants, and the like. Generally, these agents would be present in the compositions in an amount up to about 2% on a weight to volume basis.

When topically administered, the compositions of this invention are highly effective for preventing or treating ectoparasitic infection and infestation for prolonged periods of time in warm-blooded animals such as cows, sheep, horses, camels, deer, swine, goats, dogs, cats, birds, and the like. Additionally, the composition is highly effective against endoparasitic infections.

In order to facilitate a further understanding of the invention, the following examples are presented primarily for the purpose of illustrating specific embodiments thereof. The invention is not to be deemed limited thereby, except as defined in the claims.

### EXAMPLE 1

### Preparation of metaflumizone/moxidectin High Load Concentrate, Suitable for Use as a Spot-on

A 100 gram weight of dimethyl sulfoxide (DMSO) is added to 400 grams γ-hexalactone. To this solvent system is added 200 grams metaflumizone. Dissolve metaflumizone in the solvent system. Weigh 10 grams of moxidectin and add it to the current solution containing metaflumizone. Allow the moxidectin to dissolve. To the resulting solution, add 60 grams alcohol alkoxylate surfactant (sold under the tradename Synperonic® NCA) and allow the surfactant to dissolve. Lastly, bring the solution to 1000 ml with γ-hexalactone

### EXAMPLE 2

### Preparation of metaflumizone/moxidectin Pour-On from High Load Concentrate of Example 1

To 25 ml of the high load concentrate prepared in Example 1 is added q.s. to 100 ml γ-hexalactone. This provides a pour-on formulation having sufficient metaflumizone and moxidectin and volume to treat 5 head of cattle weighed 200 Kg each at 5 mg/kg dose rate metaflumizone and ? mg/kg dose rate moxidectin.

### EXAMPLE 3

### Preparation of High Load Concentrate for use as a Concentrate to Prepare metaflumizone Spray or Feed/Water Supplement

12.59 grams of metaflumizone is added to methoxypropyl acetate using mild heating (approximately 40° C.). To this solution is added 109.92 grams polyethoxylated castor oil (sold under the tradename Cremophor® EL), with stirring, followed by 1.0 grams moxidectin and then brought to volume with methoxypropyl acetate. The resultant solution is stored until ready for use, whereupon it can be diluted with water for use as a spray (17 ml of concentrate diluted to 3500 ml with water), or with water for use as a feed/water additive (in approximately the same ratio or additionally, applied directly as a backline pour-on

### EXAMPLE 4

### Preparation of Various Formulations of a metaflumizone/moxidectin High Load Concentrate, Suitable for Use as a Spot-on Treatment

| Formulation: | 1 | 2 | 3 | 4 | 5 | 6 | 7 | 8 | 9 |
|---|---|---|---|---|---|---|---|---|---|
| Moxidectin | 0.1 | 0.5 | 2.5 | 0.1 | 0.5 | 2.5 | 0.1 | 0.5 | 2.5 |
| Metaflumizone | 30 | 30 | 30 | 20 | 20 | 20 | 5 | 5 | 5 |
| Nonylphenol | 5 | | | | | 5 | 5 | | |
| ethoxylate | | | | | | | | | |
| alcohol | | 5 | | | 5 | | | 5 | |
| ethoxylate, | | | | | | | | | |
| e.g. Synperonic ® NCA | | | | | | | | | |
| Dioctyl sodium | | | 5 | | | | | | 5 |
| sulfosuccinate | | | | | | | | | |
| Cineole | 10 | | | | | | | | |
| DEET | | 10 | | | | | | | |
| IPM | | | 10 | | | | | | |
| Methoxypropyl | | | | | 10 | 10 | 10 | 10 | 10 |
| acetate | | | | | | | | | |
| DMSO | 10 | 10 | 10 | 10 | | | | | |
| γ-hexalactone | qs | qs | qs | qs | qs | qs | qs | qs | qs |

The preceding formulations are prepared using essentially the same procedures as are listed in Example 1.

### EXAMPLE 5

### Preparation of Various Formulations of a metaflumizone/macrolide High Load Concentrate, Suitable for Use as a Spot-on

| | Formulation: | | |
|---|---|---|---|
| | 10 | 10B | 10C |
| Ivermectin | | | 5 |
| Avermectin | | 5 | |
| Moxidectin | 5 | | |
| Metaflumizone | 30 | 30 | 20 |
| alcohol ethoxylate, | 5 | 5 | 5 |
| e.g. Synperonic NCA | | | |
| Methoxypropyl acetate | 10 | 10 | 10 |
| γ-hexalactone | qs | qs | qs |

The preceding formulations are prepared using essentially the same procedures as are listed in Example 1.

### EXAMPLE 6

### Preparation of Various Formulations of a metaflumizone/moxidectin High Load Concentrate, Suitable for Use as a Spot-on

| Formulation: | 11 | 12 | 14 | 15 | 16 | 17 | 18 | 19 | 20 |
|---|---|---|---|---|---|---|---|---|---|
| Moxidectin | 0.1 | 0.5 | 0.1 | 1 | 10 | 0.25 | 5 | 0.1 | 0.1 |
| Metaflumizone | 30 | 30 | 20 | 20 | 20 | 5 | 5 | 5 | 5 |
| Cineole | | | | | | | | | |
| DEET | | | | | | | | | |
| Isopropyl | 5 | | | | 1 | | | | |
| myristate | | | | | | | | | |
| poly- | | 5 | | 1 | | 5 | 5 | 5 | 5 |
| ethoxylated | | | | | | | | | |
| castor oil | | | | | | | | | |
| Sodium lauryl | | | 1 | | | | | | |
| sulfate | | | | | | | | | |
| Methoxypropyl | | | 5 | 5 | 5 | | | | |
| acetate | | | | | | | | | |
| DMSO | 30 | 30 | | | | | | | |
| Dimethyl | | | | | | 30 | 30 | 30 | 30 |
| isosorbide | | | | | | | | | |
| γ-hexalactone | qs | qs | qs | qs | qs | qs | qs | qs | qs |

The preceding formulations are prepared using essentially the same procedures as are listed in Example 1.

What is claimed is:

1. A composition for topical administration which comprises on a weight to volume basis from about 0.1 to about 10% of a substantially water-insoluble anti-parasitic macrolide compound, about 5% to about 40% of metaflumizone; about 0% to about 15% of a penetrating agent; about 2 to about 8% of a surfactant; and about 50% to about 80% of a carrier solvent.

2. The composition according to claim 1 which comprises from about 20% to about 30% of the metaflumizone.

3. The composition in claim 1 wherein the macrolide compound is moxidectin, abamectin or ivermectin.

4. Same as claim 3 except depend from claim 2.

5. The composition according to claim 1 wherein the surfactant is a non-ionic low foam surfactant.

6. The composition according to claim 1 wherein the macrolide compound is moxidectin.

7. The composition according to claim 1 wherein the penetrating agent is dimethyl sulfoxide.

8. The composition according to claim 1 wherein the carrier solvent comprises gamma-hexalactone.

9. Same as claim 8, except depend from claim 2.

10. The composition according claim 1 wherein the carrier solvent comprises dimethyl isosorbide.

11. The composition according to claim 1 which additionally contains up to about 2% of one or more preservatives, colorants, antioxidants, or stabilizers.

12. A method for preventing or treating endoparasitic and ectoparasitic infection or infestation in a warm-blooded animal which method comprises topically administering to the animal an effective amount of a composition according to claim 1.

13. Same as claim 12, except depend from claim 2.

14. The method according to claim 12 wherein the animal is selected from the group consisting of a cow, a sheep, a horse, a camel, a deer, a swine, a goat, a dog, a cat, and a bird.

15. The method according to claim 12 wherein the composition comprises about 20% to 30% of the metaflumizone; about 10% of a bridging agent, about 2% to about 8% of a non-ionic low foam surfactant, and about 50-60% carrier solvent.

16. Same as claim 15, except depend from claim 13.

17. The method according to claim 12 wherein the composition comprises gamma-hexalactone as the carrier solvent.

18. The method according to claim 17 wherein the composition is further diluted for use as a pour-on composition.

19. The method according to claim 12 wherein the composition comprises dimethyl isosorbide as the carrier solvent.

20. The method according to claim 19 wherein the composition is further diluted for use as a spray or feed/water additive.
